(19) United States
(12) Patent Application Publication
(10) Pub. No.: US 2019/0295516 A1
(43) Pub. Date: Sep. 26, 2019

(54) DRUM HEAD AND DRUM

(71) Applicant: YAMAHA CORPORATION, Hamamatsu-shi (JP)

(72) Inventors: Ryuji HASHIMOTO, Hamamatsu-shi (JP); Eiji ABE, Iwata-shi (JP)

(21) Appl. No.: 15/757,810

(22) PCT Filed: Sep. 14, 2016
(86) PCT No.: PCT/JP2016/077111

§ 371 Date: Mar. 6, 2018

(30) Foreign Application Priority Data
Sep. 30, 2015 (JP) 2015-195487

(51) Int. Cl. G10D 13/02

(52) U.S. Cl. CPC G10D 13/027; G10D 13/028; G10D 13/022

(57) ABSTRACT

A drum head includes: a head portion in which an opening is formed along a periphery of the head portion; and a protective skin closing the opening and having air permeability.

### TECHNICAL FIELD

The present invention relates to a technique for reducing the volume of sound produced by strike on a drum.

### BACKGROUND ART

In general, acoustic drums produce a large sound when a drum head is struck. Thus, reduction in sound volume is required, depending upon a place where the drum is played and a balance between the volume of sound produced by the drum and the volume of sound produced by other musical instruments to be played with the drum.

There have been proposed various constructions for reducing the volume of sound produced by drums. For example, Patent Document 1 discloses a construction in which various kinds of mute components are attached to a striking surface of a drum head and a portion of a back surface of the drum head from the striking surface. In this construction, when the drum head is struck, these mute components absorb vibration of the drum head to reduce the volume of sound produced by the drum head.

Patent Document 2 discloses a drum head having a multiplicity of small holes formed in the entire drum head. Each opening of the small holes has an extremely small diameter which ranges between one-tenth of several millimeters and several millimeters, for example. In this construction, the multiplicity of small holes increase an opening ratio of the drum head. Thus, even when the drum head is struck and vibrated, an amplitude of the drum head is small, resulting in reduced volume of sound produced by the drum head.

### PRIOR ART DOCUMENTS

### Patent Document

Patent Document 1: U.S. Pat. No. 5,637,819
Patent Document 2: Japanese Patent No. 3835084

### SUMMARY OF THE INVENTION

### Problem to be Solved by the Invention

However, in the drum constructed such that the mute components are attached to the drum head as in Patent Document 1, the length of sustain of sound produced by strike is considerably shorter than that of sound produced by a normal drum not provided with the mute components, resulting in no sustain of sound. Thus, a tone color of sound produced by the drum using the mute components is unclear or unnatural (deteriorated) when compared with a tone color of sound produced by the common drum.

In the drum head formed with the multiplicity of small holes in Patent Document 2, a loss of energy (i.e., a friction loss) in flow of air through the small holes into and out of the drum is large, and the length of sustain of sound produced by the drum is considerably shorter than that of sound produced by the common drum. That is, a tone color of sound produced by the drum is unfortunately unnatural like the technique disclosed in Patent Document 1.

Thus, since the techniques disclosed in Patent Document 1 and Patent Document 2 deteriorate the tone color, the techniques are not appropriate for reducing the sound volume when the drum is played for an audience. Furthermore, the technique disclosed in Patent Document 2 may cause stress concentration on the drum head near the small holes, which may lead to breakage of the drum head when the drum head is struck.

The present invention has been developed in view of the above-described situations, and it is an object of the present invention to provide a technique capable of reducing the possibility of breakage of a drum head due to strike and reducing the volume of sound produced by strike while achieving a tone color close to that of sound produced by a common drum.

### Means for Solving Problem

To solve the above-described problem, one aspect of the present invention provides a drum head comprising: a head portion in which an opening is formed along a periphery of the head portion; and a protective skin closing the opening and having air permeability.

In the drum head according to the present invention, the opening is closed by the protective skin, and an edge portion of the opening is protected by the protective skin. Thus, a drum installed with the drum head according to the present invention can reduce the possibility of breakage of the drum head due to strike. This reduction can increase the size of the opening and increase an opening ratio of the drum head, resulting in reduced volume of sound produced by strike. In addition, the protective skin has air permeability, preventing hindrance to flow of air into and out of the drum through the opening. Thus, it is possible to achieve a tone color close to that of sound produced by a common drum (a drum installed with a drum head not having the opening).

In a preferred form, an area of the protective skin is greater than an area of the opening. According to this form, the protective skin can be firmly secured to the head portion at an overlapping portion of the protective skin and the head portion as a sticking margin. The securing of the protective skin increases the strength of the edge portion of the opening, resulting in reduction in the possibility of breakage of the drum head due to strike.

In a preferred form, the head portion comprises a first surface to be struck, and the protective skin is secured to a second surface of the head portion which is a surface located on an opposite side of the head portion from the first surface. The protective skin is secured to the second surface of the head portion such that an outer edge of the protective skin surrounds an outer edge of the opening. According to this form, the protective skin can be secured to the head portion without any effects on the first surface. In a preferred form, the protective skin is secured to the second surface of the head portion at a region located between the outer edge of the protective skin and the outer edge of the opening. According to this form, the protective skin can reliably close the opening of the head portion. In a preferred form, a plurality of openings each as the opening are formed in the head portion so as to be arranged along the periphery of the head portion, and the protective skin is one protective skin closing all the plurality of openings. The one protective skin is secured to the second surface of the head portion at regions respectively surrounding outer edges of the plurality of openings. According to this form, the plurality of openings are closed by the one protective skin, facilitating securing the protective skin to the head portion. In a preferred form, the protective skin has a mesh shape. A drum installed with the drum head according to this form, the protective skin further prevents hindrance to flow of air into and out of the drum through the openings. Thus, it is possible to achieve a tone color close to that of sound produced by the common drum. In a preferred form, an opening ratio of a mesh of the protective skin is greater than or equal to 30% and less than or equal to 60%. According to this form, it is possible to achieve a drum head with a small lowering of tone color when compared with a normal head portion. Also, the head portion and the protective skin are formed of PET resin and the head portion and the protective skin are secured to each other by melting due to ultrasonic vibration. According to this form, the protective skin can be secured to the head portion well. In a preferred form, the head portion and the protective skin are secured to each other by melting of a hot-melt material disposed between the head portion and the protective skin. According to this form, the protective skin can be secured to the head portion well.

Another aspect of the present invention provides a drum comprising the drum head according to one of the above-described forms. According to this aspect, it is possible to reduce the possibility of breakage of the drum head due to strike and reduce the volume of sound produced by strike while achieving a tone color close to that of sound produced by the common drum.

### BRIEF DESCRIPTION OF THE DRAWINGS

FIG. 1(a) is a plan view of a drum head used in a drum according to a first embodiment of the present invention, FIG. 1(b) is a side view of the drum head, and FIG. 1(c) is a cross-sectional view taken along line IB-IB in FIG. 1(a).

FIG. 2(a) is a plan view of a drum head used in a drum according to a second embodiment of the present invention, FIG. 2(b) is a side view of the drum head, and FIG. 2(c) is a cross-sectional view taken along line IIB-IIB in FIG. 2(a).

FIG. 3(a) is a plan view of a drum head used in a drum according to a modification (2) of the present invention, FIG. 3(b) is a side view of the drum head, and FIG. 3(c) is a cross-sectional view taken along line IIIB-IIIB in FIG. 3(a).

### EMBODIMENTS

Hereinafter, there will be described embodiments of the present invention by reference to the drawings.

### First Embodiment

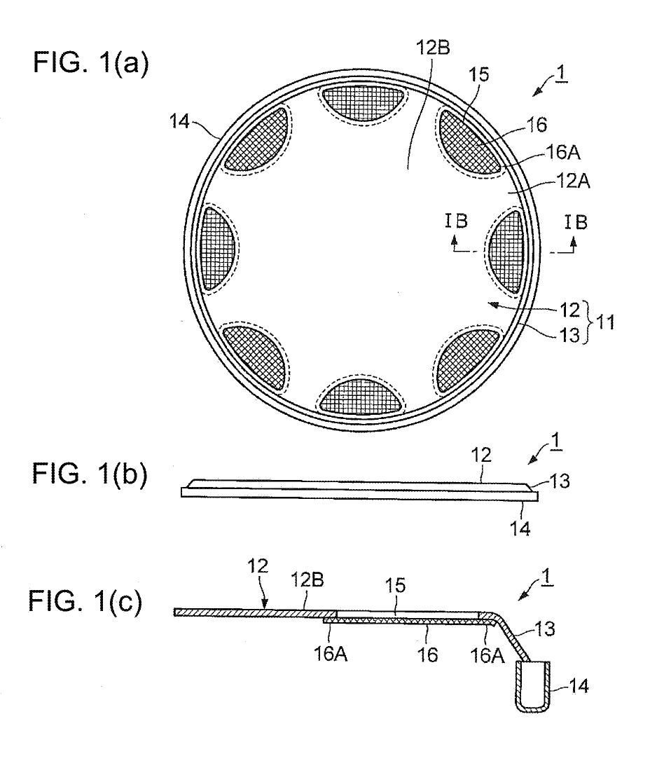

FIG. 1(a) is a plan view of a drum head 1 used for a drum according to a first embodiment of the present invention, FIG. 1(b) is a side view of the drum head 1, and FIG. 1(c) is a cross-sectional view taken along line IB-IB in FIG. 1(a). The drum head 1 is mounted in one of openings of a cylindrical shell (a body) and used as a striking surface of the drum.

The drum head 1 includes: a head portion 11 having a round shape and constituted by a skin formed of commonly used polyethylene terephthalate (PET) having a thickness of 250 μm; and a flesh hoop 14. The flesh hoop 14 is coupled to an outer edge of the head portion 11 to keep the round shape of the head portion 11. The flesh hoop 14 has an annular shape, and the inside diameter of the flesh hoop 14 is greater than the outside diameter of the shell 2.

The head portion 11 includes: an effective vibration skin 12 inside an edge portion of the one-side opening of the shell; and an outer skin 13 formed integrally with an outer edge of the effective vibration skin 12 and provided outside the edge portion of the one-side opening of the shell. The effective vibration skin 12 effectively vibrates when struck in a state in which the drum head 1 is mounted in the one-side opening of the shell. In FIG. 1, also in a state in which the drum head 1 is not mounted on the shell, the outer skin 13 extends from an outer edge of the effective vibration skin 12 so as to be inclined in the thickness direction of the effective vibration skin 12, toward an outside in the radial direction of the effective vibration skin 12. However, the present invention is not limited to this construction.

As illustrated in FIG. 1, the effective vibration skin 12 has an outer region 12A in which a plurality of openings 15 are formed. The outer region 12A is a region on the effective vibration skin 12 which is not to be struck or need not be struck in playing. This arrangement of the openings 15 reduces the area of the effective vibration skin 12, so that the volume of sound produced by strike on the present drum is less than that of sound produced by common drums. A region on the effective vibration skin 12 which is to be struck in playing will be referred to as “central region 12B”. The drum head 1 is struck with drum sticks. To ensure enough size of the central region 12B, the radius of the central region 12B is preferably set to 75 percent of the radius of the effective vibration skin 12, for example.

An inner edge portion of each of the openings 15 is curved so as to protrude toward the center of the effective vibration skin 12. In the present embodiment, the dimension of the opening 15 in the radial direction of the effective vibration skin 12 is less than the dimension of the opening 15 in the circumferential direction of the effective vibration skin 12. Thus, the area of the opening 15 can be made large enough with enough area of the central region 12B.

The openings 15 have the same shape and the same dimension. The area of each of the openings 15 in the effective vibration skin 12 is preferably greater than or equal to 78 mm², for example.

The openings 15 are spaced uniformly in the circumferential direction of the effective vibration skin 12. Since the openings 15 having the same shape and the same dimension are spaced uniformly, symmetry of the drum head 1 is well ensured, and all the vibrating modes of the struck drum head 1 can be brought closer to vibrating modes of a drum head not having the openings 15. Accordingly, a tone color of the sound produced by the drum installed with the drum head 1 is close to that of sound produced by a drum installed with a common drum head (the drum head not having the openings 15) when compared with sound produced by a drum installed with a drum head having openings with different shapes and sizes or a drum head having openings not uniformly spaced. It is noted that the drum installed with a common drum head may be referred to as “common drum”.

As illustrated in FIG. 1, the drum head 1 has the striking surface (as one example of a first surface) as one of opposite surfaces of the drum head 1, and protective skins 16 for closing the respective openings 15 are provided on the other of the opposite surfaces of the drum head 1 for the respective openings 15. Each of the protective skins 16 is a thin skin shaped like a mesh. The protective skin 16 is formed by plain knitting of common PET fibers each having a fiber diameter of about 200 μm. This mesh shape provides the protective skins 16 with air permeability. Thus, even in the configuration in which the openings 15 are covered with the respective protective skins 16, no effects are given to flow of air into and out of the drum through the openings 15 with the drum is struck.

The shape of each of the protective skins 16 is similar to that of each of the openings 15, but the area of the protective skin 16 is greater than that of the opening 15. The protective skins 16 are fixed to the drum head 1 such that outer edges of the respective protective skins 16 respectively surround outer edges of the respective openings 15. Thus, each of the protective skins 16 has a portion overlapping a region near a corresponding one of the openings 15. This overlapping portion is a fixed portion 16A. The fixed portion 16A serves as a sticking margin at which the protective skin 16 is fixed to the head portion 11. In the present embodiment, fixation of the protective skin 16 to the head portion 11 prevents separation of the protective skin 16 from the head portion 11 when the drum is struck. Examples of a method of this fixation include bonding and sticking. In the present embodiment, welding using ultrasonic vibration is employed because the head portion 11 and the protective skin 16 are formed of the same PET resin. Specifically, the method of this welding is as follows: ultrasonic vibration is caused to generate frictional heat on both of the fixed portions 16A and portions of the head portion 11 near the openings 15 to melt the fixed portions 16A and the portions of the head portion 11; and the melted fixed portions 16A and the melted portions of the head portion 11 are respectively compressed and bonded together to fix the head portion 11 and the protective skins 16 to each other. It is noted that ultrasonic welding is employed as the method for fixing the protective skins 16 to the head portion 11 in the above-described embodiment, but, instead of the ultrasonic welding, hot melt may be used to fix the protective skins 16 to the head portion 11. In the case where the hot melt is employed, hot-melt materials are disposed between the head portion 11 and the protective skins 16 and heated to melt the hot-melt materials. The melted hot-melt materials are combined with the head portion 11 and the protective skins 16, so that the protective skins 16 are fixed to the head portion 11. The hot-melt materials are formed of PET resin like the head portion 11 and the protective skins 16. One example of the hot-melt materials is PET resin having a thickness ranging between 25 μm and 100 μm and having a melting temperature of 150 degrees. In this case, the protective skins 16 can be well fixed to the head portion 11.

The feature of the present embodiment is the protective skins 16 provided for closing the respective openings 15. Without the protective skins 16, the following situations may occur. Since the area of each of the openings 15 is large, the drum stick may be caught by the edge of the opening 15 by mistake when the drum is struck, which may lead to a hindrance to playing.

Also, when the drum head 1 is mounted in the one-side opening of the shell, a degree of stretch of the head portion 11 is adjusted (tuned) by a tensioner, not illustrated in FIG. 1. However, since the openings 15 are formed at the outer region 12A of the effective vibration skin 12, the head portion 11 cannot be tensioned uniformly. Thus, the effective vibration skin 12 is not vibrated uniformly when the drum is struck, and the tone color of sound produced by the strike is considerably different from that of sound produced by the common drum.

Also, stress concentration occurs at portions of the effective vibration skin 12 near the openings 15 when the drum is struck, resulting in lowered durability of the effective vibration skin 12. Thus, when the portions of the effective vibration skin 12 near the openings 15 are struck, the drum head 1 may be broken from the portions of the effective vibration skin 12 near the openings 15.

However, the openings 15 are closed by the respective protective skins 16 in the drum head 1 according to the present embodiment. Thus, when the drum is struck, a distal end of the drum stick is not caught by the edge of the opening 15, resulting in no hindrance to playing. Moreover, when the drum head 1 is mounted in the one-side opening of the shell, the entire outer edge of the effective vibration skin 12 can be tensioned uniformly. Accordingly, the effective vibration skin 12 is vibrated uniformly when the drum is struck, and the tone color of sound produced by strike is close to that of sound produced by the common drum. Also, the fixed portions 16A are fixed to the edge portions of the respective openings 15 in the drum head 1. This configuration increases the strength of the edge portions, resulting in reduced possibility of breakage of the drum head 1 from the portions of the effective vibration skin 12 near the openings 15 when the drum is struck.

In the drum according to the present embodiment, since the openings 15 are formed at the outer region 12A of the effective vibration skin 12, the size of each of the openings 15 is large. This configuration can reduce or prevent a loss of energy in flow of air through the openings 15 into and out of the drum installed with the drum head 1. As a result, the length of sustain of sound produced by the strike is close to that of sustain of sound produced by the common drum.

The openings 15 formed in the effective vibration skin 12 are closed by the respective protective skins 16, but the protective skins 16 have air permeability. Thus, no effects are given to the flow of air into and out of the drum through the openings 15, and the tone color of sound produced by strike is close to that of sound produced by the drum installed with the common drum head.

In view of the above, the drum according to the present embodiment can reduce the possibility of breakage of the drum head due to strike and reduce the volume of sound produced by strike while achieving a tone color close to that of sound produced by the common drum. Since it is possible to achieve the tone color close to that of sound produced by the common drum, the drum installed with the drum head 1 can be used not only for practice but also for playing for an audience.

The method of mounting the drum head 1 onto the drum is the same as that of mounting the common drum head onto the drum. Thus, the degree of stretch of the head portion 11 can be tuned with the tensioner in the same manner as that of the common drum.

In the present embodiment, an amount of adjustment of the sound volume is determined by an opening ratio of the drum head 1. For example, increase in the opening ratio of the drum head 1 can decrease the volume of produced sound. Accordingly, various kinds of drum heads having different opening ratios can be prepared, and a player can select one of the drum heads which produces sound of a volume required for playing.

### Second Embodiment

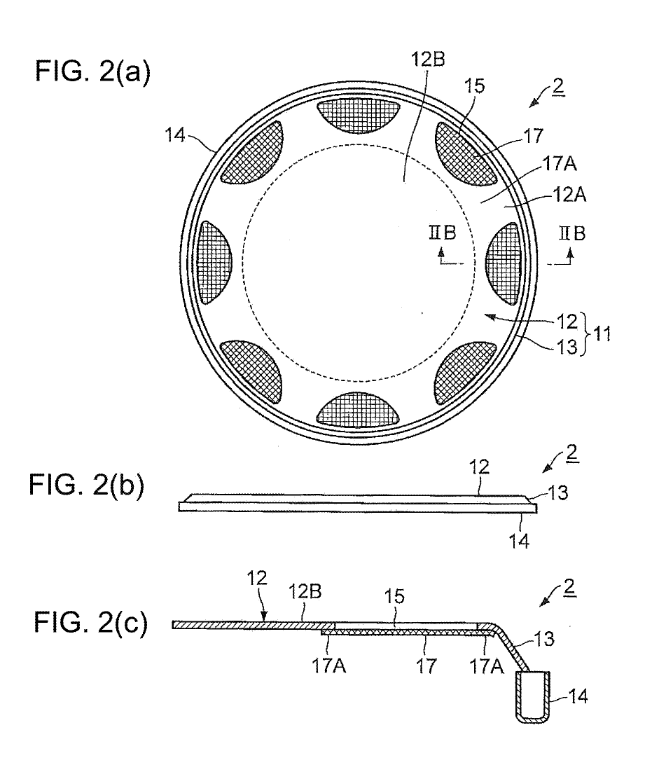

FIG. 2(a) is a plan view of a drum head 2 used in a drum according to a second embodiment of the present invention, FIG. 2(b) is a side view of the drum head 2, and FIG. 2(c) is a cross-sectional view taken along line IIB-IIB in FIG. 2(a). The same reference numerals as used in FIG. 2 are used to designate the corresponding elements in FIG. 1. A difference between the drum head 1 and the drum head 2 is an annular protective skin 17 provided instead of the protective skins 16. There will be described the second embodiment, focusing on the protective skin 17.

Like the protective skins 16, the protective skin 17 is a thin skin shaped like a mesh and is formed by plain knitting of PET fibers each having a fiber diameter of about 200 μm. That is, the protective skin 17 in the present embodiment is formed of the same PET resin of the head portion 11. Like the protective skins 16, the protective skin 17 gives no effects to the flow of air through the openings 15 into and out of the drum installed with the drum head 2. The shape of the protective skin 17 is an annular shape that is different from that of the protective skins 16. The protective skin 17 is provided along the outer edge of the effective vibration skin 12. Though the number of the protective skins 16 corresponds to the number of the openings 15, the single protective skin 17 is provided in the present embodiment.

The protective skin 17 has a fixed portion 17A that does not overlap the openings 15. The fixed portion 17A serves as a sticking margin at which the protective skin 17 is fixed to the head portion 11. A method of fixation of the protective skin 17 is the same as that of fixation of the protective skins 16.

The drum head 2 is easier than the drum head 1 in manufacture because the single protective skin 17 is provided on the drum head 2 while the protective skins 16 are provided for the respective openings 15 in the drum head 1.

In view of the above, the same effects as achieved in the first embodiment are achieved in the present embodiment. Furthermore, the drum head 2 according to the present embodiment is easier in manufacture than the drum head 1 according to the first embodiment.

### Other Embodiments

While the first and second embodiments of the present invention have been described above, the present invention may be embodied as other embodiments, examples of which are as follows.

(1) While each of the protective skins 16, 17 is formed by plain knitting of the common PET fibers each having the fiber diameter of about 200 μm in each of the above-described embodiments, the fiber diameter of the fiber and the distance between the fibers constituting the protective skins 16, 17 are not limited to those in the above-described embodiments. Each of the protective skins 16, 17 only needs to have such a fiber diameter and a distance that prevent hindrance to playing due to the distal end of the drum stick being caught by the edge of the opening 15 when the drum is struck. In the case where an opening ratio of the mesh of the protective skins 16 is represented by expression “(an opening)*100/(the opening+the fiber diameter)” where the fiber diameter is the diameter of each of the PET fibers used in the protective skins 16, and the opening is a distance between fibers of the PET fibers used in the protective skins 16, the opening ratio of the PET fibers used in the above-described embodiment is preferably greater than or equal to 30% and less than or equal to 60% but more preferably greater than or equal to 36% and less than or equal to 60%. Also, in the case where PET fibers in which the opening ratio is 36%, the fiber diameter is 200 μm, and the opening is 300 μm were used, a drum head was obtained with reduced deterioration of the tone color when compared with the common drum head. Also, even in the case where PET fibers in which the opening ratio is 60%, the fiber diameter is 410 μm, and the opening is 1400 μm were used, a drum head was obtained with reduced deterioration of the tone color when compared with the common drum head. Fibers constituting the protective skins 16, 17 may be metal fibers or glass fibers.

While each of the protective skins 16, 17 is shaped like a mesh in each of the above-described embodiments, the shape of each of the protective skins 16, 17 is not limited to the mesh shape as long as no effects are given to the flow of air into and out of the drum through the openings 15 of the drum installed with each of the drum heads 1, 2. In short, each of the openings 15 only needs to be closed by the protective skin having air permeability. For example, each of the openings 15 may be closed by a protective skin formed of fibers arranged only in one direction, instead of the protective skins 16, 17. While each of the protective skins 16, 17 is provided on the surface of the drum head 1 which is located on an opposite side of the drum head 1 from the striking surface in the above-described embodiments, each of the protective skins 16, 17 may be provided on the striking surface of the drum head 1.

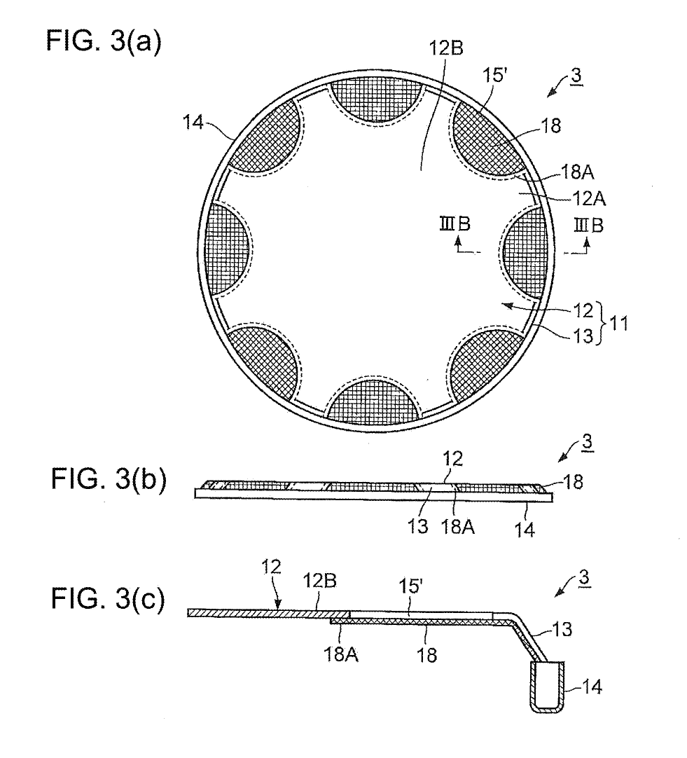

(2) While the openings 15 are formed in the effective vibration skin 12 in each of the above-described embodiments, each of the openings 15 may be formed over the effective vibration skin 12 and the outer skin 13. FIG. 3(a) is a plan view of a drum head 3 used in a drum according to the modification (2) of the present invention, FIG. 3(b) is a side view of the drum head 3, and FIG. 3(c) is a cross-sectional view taken along line IIIB-IIIB in FIG. 3(a). As illustrated in FIG. 3, each of openings 15′ formed in the drum head 3 extends to the flesh hoop 14. An inner edge portion of each of the openings 15′ is curved so as to protrude toward the center of the effective vibration skin 12. Protective skins 18 are provided so as to close the respective openings 15′. The shape of each of the protective skins 18 is similar to that of each of the openings 15′, but the area of each of the protective skins 18 is greater than that of each of the openings 15′. Fixed portions 18A serve as sticking margins when the protective skins 18 are fixed to the head portion 11. Like the protective skins 16, 17, each of the protective skins 18 is formed by plain knitting of PET fibers. Also, the protective skins 18 are the same as the protective skins 16, 17 in the fiber diameter and the distance in the protective skins 18 and the method of fixation to the head portion 11. Like the protective skin 17 in the second embodiment, the protective skin 18 may have an annular shape and extend along the outer edge of the head portion 11. The protective skins 18 may be provided on the surface of the drum head 1 which is located on an opposite side of the drum head 1 from the striking surface and may be provided on the striking surface.

As understood from the configuration in which the openings 15′ extend to the flesh hoop 14, the area of each of the openings 15′ is greater than that of each of the openings 15. Thus, the opening ratio of the drum head 3 is greater than that of the drum head 1, thereby further reducing the volume of sound produced by strike. Moreover, this configuration can further reduce or prevent a loss of energy in flow of air through the openings 15′ into and out of the drum installed with the drum head 3. As a result, the length of sustain of sound produced by the strike is further made close to that of sustain of sound produced by a common drum (a drum installed with a drum head not having the openings 15′).

(3) While the entirety of each of the openings 15 is closed by the protective skin 16 or 17 in each of the above-described embodiments, only a portion of each of the openings 15 may be closed by the protective skin 16 or 17.

### EXPLANATION OF REFERENCE NUMERALS

1, 2, 3: Drum Head, 11: Head Portion, 12: Effective Vibration Skin, 12A: Outer Region, 12B: Central Region, 13: Outer Skin, 14: Flesh Hoop, 15, 15′: Opening, 16, 17, 18: Protective Skin, 16A, 17A, 18A: Fixed Portion

1. A drum head, comprising:
a head portion in which an opening is formed along a periphery of the head portion; and
a protective skin closing the opening and having air permeability.

2. The drum head according to claim 1, wherein an area of the protective skin is greater than an area of the opening.

3. The drum head according to claim 1,
wherein the head portion comprises a first surface to be struck, and
wherein the protective skin is secured to a second surface of the head portion which is a surface located on an opposite side of the head portion from the first surface.

4. The drum head according to claim 3, wherein the protective skin is secured to the second surface of the head portion such that an outer edge of the protective skin surrounds an outer edge of the opening.

5. The drum head according to claim 4, wherein the protective skin is secured to the second surface of the head portion at a region located between the outer edge of the protective skin and the outer edge of the opening.

6. The drum head according to claim 3,
wherein a plurality of openings each as the opening are formed in the head portion so as to be arranged along the periphery of the head portion, and
wherein the protective skin is one protective skin closing all the plurality of openings.

7. The drum head according to claim 6, wherein the one protective skin is secured to the second surface of the head portion at regions respectively surrounding outer edges of the plurality of openings.

8. The drum head according to claim 1, wherein the protective skin has a mesh shape.

9. The drum head according to claim 1, wherein an opening ratio of a mesh of the protective skin is greater than or equal to 30% and less than or equal to 60%.

10. The drum head according to claim 1,
wherein the head portion and the protective skin are formed of PET resin, and
wherein the head portion and the protective skin are secured to each other by melting due to ultrasonic vibration.

11. The drum head according to claim 1, wherein the head portion and the protective skin are secured to each other by melting of a hot-melt material disposed between the head portion and the protective skin.

12. A drum comprising
a drum body; and
a drum head, the drum head comprising:
a head portion in which an opening is formed along a periphery of the head portion; and
a protective skin closing the opening and having air permeability.
